(19) United States
(12) Patent Application Publication
(10) Pub. No.: US 2011/0102356 A1
(43) Pub. Date: May 5, 2011

(54) PORTABLE ELECTRONIC DEVICE WITH A PLURALITY OF HINGED CONFIGURATIONS AND ASSOCIATED METHOD

(75) Inventors: Pasi Kemppinen, Tampere (FI); Mika Hautamaki, Vesilahti (FI)

(73) Assignee: NOKIA CORPORATION, Espoo (FI)

(21) Appl. No.: 13/001,569

(22) PCT Filed: Jun. 27, 2008
(86) PCT No.: PCT/EP08/05296

§ 371 Date: Dec. 27, 2010

(51) Int. Cl. H04W 88/02; G06F 3/041

(52) U.S. Cl. 345/173; 455/575.3; 455/566

(57) ABSTRACT

There is provided an apparatus for providing a plurality of hinged configurations to first/second members of a portable electronic device, the apparatus comprising a hinge mechanism configured to provide for a closed configuration of the device in which the first member of the device overlays the second member, a partially open configuration in which the first/second members are slid with respect to one another compared to the closed configuration such that the members are laterally displaced with respect to one another along an axis of the hinge mechanism so as to expose a user interface, and an open configuration in which the first/second members are rotated relative to one another around the axis of the hinge mechanism compared to the closed configuration so as to expose an inner surface region of each member, and wherein the apparatus is configured to urge one or more of the first/second members so as to provide for removal of the lateral displacement when the device is urged from the partially open configuration toward the open configuration.

### TECHNICAL FIELD

The present invention relates to the field of hinges for portable electronic devices associated apparatus and methods. Certain embodiments of the invention relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices of the present invention may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), gaming functions, word processing, spreadsheets, databases, etc.

### BACKGROUND

There is a desire to provide portable electronic devices that are compact, but that offer increased functionality. There is also a desire to provide device that are easy to operate.

The listing or discussion of a prior-published document or any background in this specification should not necessarily be taken as an acknowledgement that the document or background is part of the state of the art or is common general knowledge. One or more aspects/embodiments of the present invention may or may not address one or more of the background issues.

### SUMMARY

In a first aspect, there is provided an apparatus for providing a plurality of hinged configurations to first/second members of a portable electronic device, the apparatus comprising a hinge mechanism configured to provide for a closed configuration of the device in which the first member of the device overlays the second member, a partially open configuration in which the first/second members are slid with respect to one another compared to the closed configuration such that the members are laterally displaced with respect to one another along an axis of the hinge mechanism so as to expose a user interface, and an open configuration in which the first/second members are rotated relative to one another around the axis of the hinge mechanism compared to the closed configuration so as to expose an inner surface region of each member, and wherein the apparatus is configured to urge one or more of the first/second members so as to provide for removal of the lateral displacement when the device is urged from the partially open configuration toward the open configuration.

The apparatus may be further configured to allow for removal of the lateral displacement when the device is in the partially open configuration so as to return (e.g. slidably return) the device to the closed configuration.

The apparatus may be provided with a releaser. The releaser may be configured to be user operable in order to slidably return the device to the closed configuration (e.g. by a user pushing a release button, or the like).

The releaser may comprise a retaining element. The releaser may comprise a complementary retainer. The retainer may be configured for contact (e.g. locking contact) with the retaining element when the device is in the partially open configuration.

The releaser (e.g. retaining element/retainer) may be configured for magnetic locking contact. The retaining element may comprise a magnetic material. The retainer may be metallic, and/or may be in the proximity of a metallic material (e.g. a metallic strip provided below the retainer).

The releaser may further comprise a release element. The release element may be configured to remove/reduce the locking contact of the retainer/retaining element. The release element may be configured to allow for urging of the retaining element from the retainer (e.g. by a user when the device is in the partially open configuration) so as to remove/reduce the locking contact.

The apparatus may be configured such that bias energy is provided (e.g. provided by the user, provided by an actuator, such as a motor) when the first member is slid with respect to the second member so as to provide the partially open configuration. The apparatus may be configured such that the bias energy can be subsequently used to remove the lateral displacement.

The hinge mechanism may comprise a bias element (e.g. a bias spring) to store/return the bias energy. The hinge mechanism may comprise more than one bias element/spring.

The hinge mechanism may comprise a first and second hinge portion. The first/second hinge portion may be configured to be slideable along an axis of the second/first hinge portion so as to provide the closed and partially open configurations. The first/second hinge portion may be configured to be rotatable around an axis of the second/first hinge portion so as to provide the closed and open configurations.

One of the first and second hinge portions may be cylindrical. One of the first and second hinge portions may house a bias spring. The bias spring may be housed in a cavity defined between the first and second hinge portion.

The first/second hinge portion may be configured to restrain a housed bias spring so as to provide for storing the said bias energy when moving from an open/closed configuration to a partially open configuration. The first/second hinge portion may be configured to restrain a housed bias spring so as to provide for returning the said bias energy when moving from a partially open configuration to a closed configuration.

The apparatus may further comprise a slide element (e.g. a metallic strip). The slide element may be configured to be provided on an inner surface region of a first/second member of a device. The slide element may configured to be embedded (e.g. fully/partially embedded) in a first/second member. The slide element may be configured to interact (e.g. magnetically interact, so as to attract) with the retaining element on the other member of the device. The slide element/retaining element may be configured such that they hold (e.g. magnetically attract so as to hold) a device in the closed configuration. The slide element/retaining element may be configured such that they hold (e.g. magnetically attract so as to hold) a device so as to slide from the closed configuration to the partially open configuration (and visa versa).

According to a second aspect there is provided a member for an electronic device comprising an apparatus according to any of the features of the first embodiment. The member may comprise one of at least one user input and at least one display.

According to a third aspect there is provided a portable electronic device comprising a first member, a second member and an apparatus according to any of the features of the first aspect, the device configured to provide the closed, partially open, and open configurations.

The first/second member may be comprised with the retaining element of the releaser, and the second/first member may be comprised with the retainer. The release element may be provided on the first/second member.

The first/second member may be provided with a first/second user interface, comprising one of a keypad and a touch screen, on an inner surface region.

The first/second user input interface may comprise a partially open user region configured to provide for at least one of user input and user output when the device is in the partially open configuration.

The first/second member may be provided with a third user interface comprising one of a keypad, display and touch screen, on an outer surface region.

The device may have at least one of: mobile radiotelephone functionality; media functionality; multimedia functionality; Global Positioning System (GPS) functionality; Personal Digital Assistant (PDA) functionality; general purpose package functionality.

According to a fourth aspect there is provided a method of providing an apparatus for providing a plurality of hinged configurations to first/second members of a portable electronic device, the method comprising:

providing the apparatus with a hinge mechanism such that the hinge mechanism allows for: a closed configuration of the device in which a first member of the device overlays the second member; a partially open configuration in which the first/second members are slid with respect to one another compared to the closed configuration such that the first member is laterally displaced with respect to one another along an axis of the hinge mechanism so as to expose a user interface; and an open configuration in which the first/second members are rotated relative to one another around the axis of the hinge mechanism compared to the closed configuration so as to expose an inner surface region of each member; and

providing the apparatus such that it allows for urging of one or more of the first/second members so as to provide for removal of the lateral displacement when the device is moved from the partially open configuration toward the open configuration.

According to a fifth aspect there is provided a method of using a portable electronic device, comprising using a device comprising the apparatus according to any of the features of the first aspect.

The method may comprise using a device according to any of the features of the third aspect.

According to a sixth aspect there is provided An apparatus for providing a plurality of hinged configurations to first/second means for housing of a portable electronic device, the apparatus comprising a means for hinging configured to provide for a closed configuration of the device in which the first means for housing of the device overlays the second means for housing, a partially open configuration in which the first/second means for housing are slid with respect to one another such that the means for housing are laterally displaced with respect to one another along an axis of the means for hinging so as to expose a means for a user interface, and an open configuration in which the first/second means for housing are rotated relative to one another around the axis of the means for hinging so as to expose a an inner surface region of each of the means for housing, and wherein the means for an apparatus is configured to urge one or more of the first/second means for housing so as to provide for removal of the lateral displacement when the device is urged from the partially open configuration toward the open configuration.

According to a seventh aspect, there is provided an apparatus for providing a plurality of hinged configurations to first/second members of a portable electronic device, the apparatus comprising a hinge mechanism configured to provide for a closed configuration of the device in which the first member of the device overlays the second member and in which the respective centres of the members are aligned, a partially open configuration in which the first/second members are slid with respect to one another compared to the closed configuration such that the members are laterally displaced with respect to one another along an axis of the hinge mechanism so as to expose a user interface and such that their respective centres are no longer aligned, and an open configuration in which the first/second members are rotated relative to one another around the axis of the hinge mechanism compared to the closed configuration so as to expose an inner surface region of each member and in which the respective centres of the members are aligned, and wherein the apparatus is configured to urge one or more of the first/second members from the partially open configuration to the open configuration so as to re-align the respective centres of the members when the device is urged from the partially open configuration towards a configuration in which the first/second members are rotated with respect to one another around the axis of the hinge mechanism.

According to an eighth aspect, there is provided an apparatus for providing a plurality of hinged configurations to first/second means for housing of a portable electronic device, the apparatus comprising a means for hinging configured to provide for a closed configuration of the device in which the first means for housing of the device overlays the second means for housing and in which the respective centres of the means for housing are aligned, a partially open configuration in which the first/second means for housing are slid with respect to one another compared to the closed configuration such that the means for housing are laterally displaced with respect to one another along an axis of the means for hinging so as to expose a means for user interface and such that their respective centres are no longer aligned, and an open configuration in which the first/second means for housing are rotated relative to one another around the axis of the means for hinging compared to the closed configuration so as to expose an inner surface region of each means for housing and in which the respective centres of the means for housing are aligned, and wherein the apparatus is configured to urge one or more of the first/second means for housing from the partially open configuration to the open configuration so as to re-align the respective centres of the means for housing when the device is urged from the partially open configuration towards a configuration in which the first/second means for housing are rotated with respect to one another around the axis of the means for hinging.

The present invention includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 shows a device comprising an apparatus according to an embodiment of the present invention;

FIG. 2 shows cross-sections of a hinge mechanism of an apparatus;

FIG. 3 shows side views of a releaser for an apparatus;

FIG. 4 shows a device comprising an apparatus slidably moving to a closed configuration;

FIG. 5 shows a device comprising an apparatus moving from a partially open configuration to an open configuration;

FIG. 6 shows a non-useful configuration;

FIG. 7 shows a flowchart of a method of providing an apparatus; and

FIG. 8 shows a flowchart of a method of use of an apparatus.

### DESCRIPTION OF SPECIFIC EMBODIMENTS

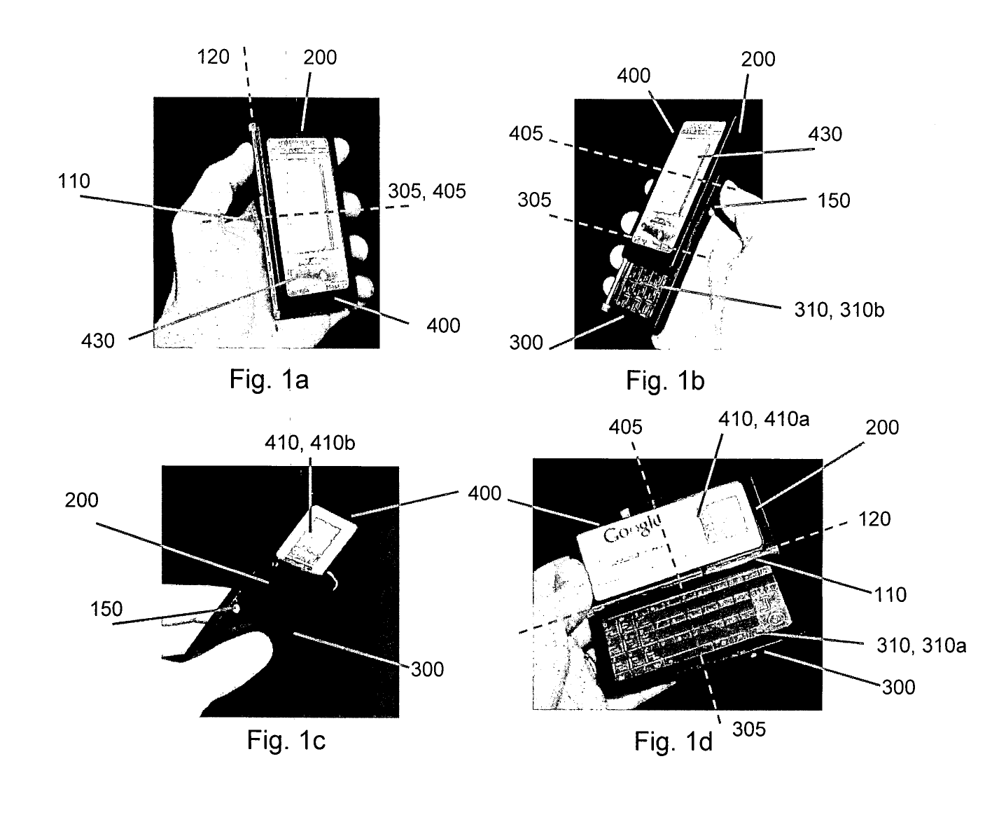

FIG. 1 shows an embodiment of an apparatus 110, 150 for providing hinged configurations comprised with a device 200, which in the present embodiment is a portable electronic device, such as a mobile telephone. The apparatus 110, 150 comprises a hinge mechanism 110 and a releaser 150 (as will be described). The device 200 comprises a first and second member 300, 400, connected to the hinge mechanism 110 of the apparatus 110, 150. The hinge mechanism 110 is configured such that it allows for rotational movement of one member relative to the other about an axis 120 of the hinge mechanism 110, and allows for lateral movement of one member relative to the other along the axis 120 of the hinge mechanism 110.

Here, both the first and second members 300, 400 have respective central axis 305, 405, or centres 305, 405, which traverse the respective members 300, 400. In the closed configuration the respective centres 305, 405 are aligned. In the partially open configuration the respective centres 305, 405 are no longer aligned, but are displaced relative to one another. In the open configuration in which the first/second members 300, 400 are rotated relative to one another around the axis 120 of the hinge mechanism 110, the respective centres 305, 405 of the members 300, 400 are again aligned.

The first member 300 is provided with a first user interface 310, which in the present embodiment is provided by a keypad 310 on an inner surface region of the first member 300. The keypad 310 has a fully open region 310a, and a partially open region 310b, each configured for user input in particular configurations of the device 200, as will be described.

The second member 400 is provided with a second user interface 410, which in the present embodiment is provided by a display 410 on an inner surface region of the second member 400. The display 410 has a fully open region 410a, and a partially open region 410b, each configured for user output in particular configurations of the device 200.

The second member 400 further comprises a third user interface 430, which in the present embodiment is provided by a display 430 on an outer surface region of the second member 400. The third interface 430 is configured for user output in a particular configuration of the device 200.

FIG. 1a shows a first (closed) configuration of the device 200 comprising the apparatus 110, 150, in which the second member 400 overlays the first member 300. In this embodiment the first member 300 and the second member 400 overlay one another such that they are aligned (e.g. their respective centres 305, 405 are aligned, which in this embodiment means that the first member 300 is largely hidden from view by the second member 400 in FIG. 1a)). Here, the first user interface 310 and the second user interface 410 are facing one-another and are concealed from view. The third user interface 430 is visible to the user, and is operable so as to provide for input/output.

FIGS. 1b and 1c show a second (partially open) configuration of the device 200 comprising the apparatus 110, 150, in which the second member 400 has been slid with respect to a first member 300, such that a second member 400 is laterally displaced along the axis 120 of the hinge mechanism 110 with respect to the first member 400 (e.g. displaced such that their respective centres 305, 405 are displaced). FIG. 1b shows the partially open configuration, in which the partially open region 310b of the first user interface 310 is exposed (e.g. for use by a user, such as, in conjunction with the third user interface 430). FIG. 1c shows the partially open configuration, in which the partially open region 410b of the second user interface 410 is exposed (e.g. for providing a second display, such as for advertising, illuminating, etc.).

FIG. 1d shows a third (open) configuration in which the second member 400 has been rotated relative to the first member 300 around the axis 120 of the hinge mechanism 110 so as to expose the first and second user interfaces 310, 410 (e.g. expose so as to be operable/viewable for use by a user). Here, the respective centres 305, 405 are again aligned.

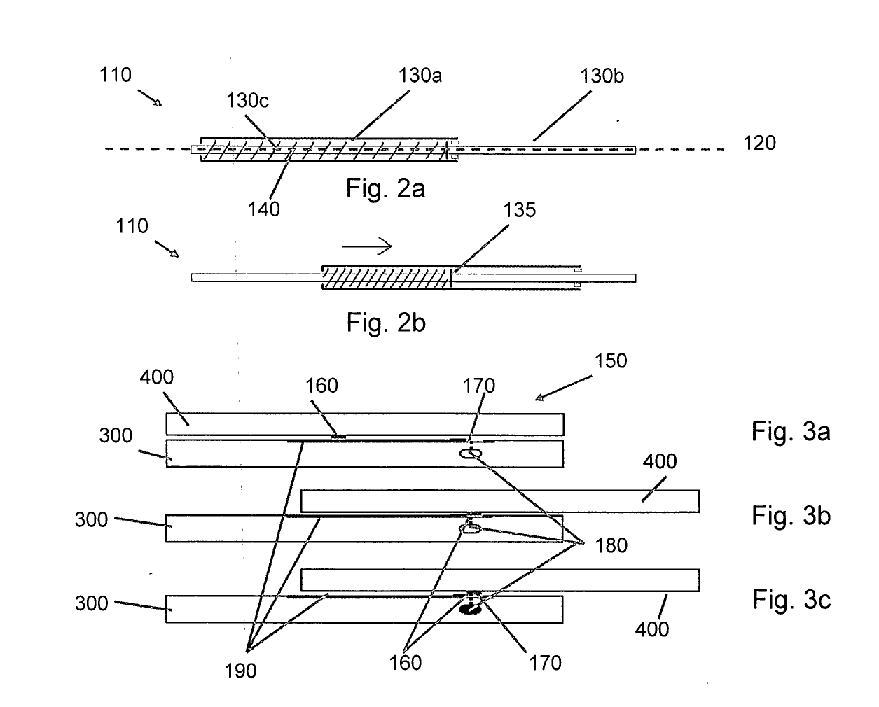

FIG. 2a shows a cross-section of the hinge mechanism 110 of the apparatus 110, 150. The hinge mechanism 110 comprises a first hinge portion 130a, a second hinge portion 130b. Here, the first hinge portion surrounds a portion of the second hinge portions (e.g. surrounds to as to provide a cavity 140. Here, the hinge mechanism further comprises a bias element 130c, which in the present embodiment is provided by a spring 130c. The first hinge portion 130a is configured to be slidable along the second hinge portion 130b.

The first hinge portion 130a is configured to be rotatable around the second hinge portion 130b. In the present embodiment both portions 130a, 130b are provided by tubular portions 130a, 130b.

The hinge mechanism 110, 150 is configured such that the bias spring 130c is retained in the cavity 140 provided between the first hinge portion 130a and the second hinge portion 130b. The spring 130c is retained at one end by the first hinge portion 130b, and at the other end by a stopper 135 on the second hinge portion, such that (and as shown in FIG. 2b) lateral movement of the first hinge portion relative to the second in a particular direction causes the spring 130c to compress (e.g. storing bias energy), while lateral movement in the opposite sense removes/uses the stored bias energy. That is, once in a compressed condition, the spring 130c is configured to want to remove the compression causing displacement of the hinge portions 130a, 130b (e.g. return the hinge mechanism 100 to an original configuration).

FIG. 3 shows a side view of the device 200 showing the releaser 150 of the apparatus 110, 150. Here, a retaining element 160 is provided on the inner surface region of the second member 400. A retainer 170 is provided on the inner surface region of the first member 300. In the present embodiment this is provided by a complementary recess (e.g. a recess provided such that the retaining element 160 may be located in the recess). The releaser 150 is further provided with a release element 180, configured to allow a user to urge (e.g. push out) the retainer element 160 from the retainer 170.

In this embodiment, the retaining element 160 is configured to be magnetic (e.g. comprising a magnetised material). The apparatus 110, 150 is additionally provided with a slide element 190, which in this embodiment is embedded under the surface region of the first member 300, and extends for a portion of the length of the first member 300. Here, the slide element 190 is provided by a metallic strip. The slide element 190 also extends under the retainer 170. The slide element 190 is configured such that it is closer to the base of the recess of the retainer 170, than the inner surface region of the first member 300 along the remainder of its length. In the present embodiment, the slide element 190 extends for a length that roughly corresponds to the lateral displacement allowed for by the hinge mechanism.

FIG. 3a shows a side view of the device 200, comprising the apparatus 110, 150, in the closed configuration (e.g. second member 400 overlaying the first member 300, in which here the first and second member 300, 400 are aligned). In the closed configuration, the retaining element 160 is configured to be in proximity of the slide element 190 (e.g. a portion of the length of the slide element 190) so as to provide an attractive force (i.e. an attractive magnetic force) that tries to resist a force which might be applied to open the device 200 to the open configuration. It will readily be appreciated that if a force is applied that overcomes the attractive force then the second member will rotate about the axis 120 of the hinge mechanism 110 so as to provide the open configuration.

FIG. 3b shows a side view of the device 200 in the partially open configuration (see the corresponding FIGS. 1b and 1c, as well as the corresponding hinge mechanism 110 configuration in FIG. 2b). Here, the second member 400 has been slid with respect to the first member 300, until the restraining element 160 is received by the retainer 170 (e.g. received and retained). The first/second member 300, 400 can be considered to have been slid along the axis 120 of the hinge mechanism 110. As this occurs, the user must provide sufficient bias energy to compress the bias spring 130c and so move the device from the closed configuration to the partially open configuration.

In this embodiment the slide element 190 is configured such that it extends for the length of desired lateral movement, as discussed (i.e. configured such that the attractive force provided between the retaining element 160 and the slide element 190, which is trying to prevent the second member 400 and the first member rotating, is provided for the length of sliding the device from the closed configuration to the open configuration).

When the retaining element 160 is retained/located in the retainer 170, the attractive forces between the retaining element 160 and the slide element 190 are increased (i.e. due to the reduction in displacement between the slide element 190 and the retaining element 160). Furthermore, the retaining element 160 is inhibited by the retainer 170 from allowing the device 200 to return to the closed configuration (i.e. the recess provided by the retainer 170 means that the compressed bias spring 130c cannot urge the first/second member 300, 400 back to the closed configuration).

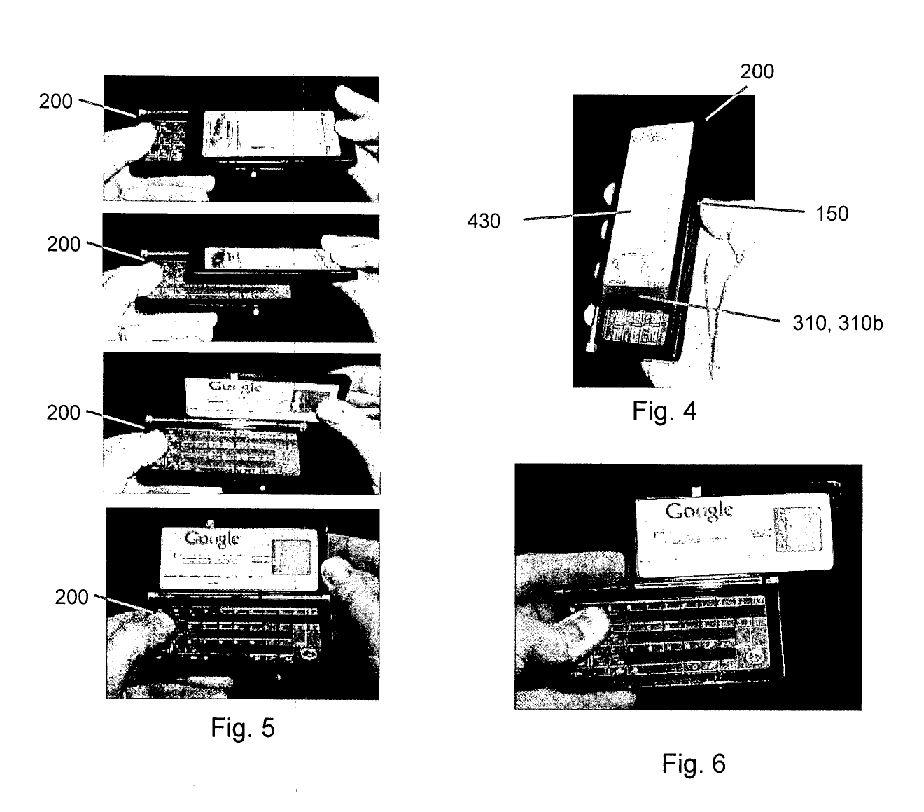

FIG. 3c shows a side view of the device 200 when the release element 180 has been used (e.g. actuated, such as depressed, by a user). Here, the retaining element 160 is urged from retainer 170, such that the bias spring 130c can act to return the device 200 to the closed configuration. FIG. 4 shows the device 200 retuning to the closed configuration after use of the release element 180 (see comparison with FIGS. 1a and 1b).

As there is provided an attractive force, which acts to hold the retaining element 160 in the retainer 170 (i.e. the retaining element 160/slide element 190 are metallic/magnetic), a user can still move the device 200 from the partially open configuration to the open configuration (e.g. by providing sufficient energy to overcome the attractive force). FIG. 5 shows such an arrangement.

In this embodiment, when the retaining element 170 is removed from the retainer 180, the compressed bias spring 130c acts to urge the device 200 to the closed configuration. Such a configuration allows for a device 200 which inhibits the accidental use of the (non-useful) configuration shown in FIG. 6.

Here, the apparatus 110, 150 is configured such that it urges one or more of the first/second members 300, 400 from the partially open configuration to the open configuration so as to re-align the respective centres 305, 405 of the members 300, 400 when the device 200 is urged from the partially open configuration towards a configuration in which the first/second members 300, 400 are rotated with respect to one another (e.g. around the axis of the hinge mechanism 110).

It will readily be appreciated that in this embodiment the device 200 is hindered from entering the non-useful configuration shown in FIG. 6. However, in alternative embodiments, the apparatus 110, 150 may be configured such that the device 200 does enter the non-useful configuration (e.g. as a transitional configuration between the partially open configuration and the open configuration, or visa versa).

It will readily be appreciated that in some embodiments the function of the bias spring 130c may not be provided by a spring, but may be provided by an alternative/additional actuator, such as an electrical/mechanical actuator, pressure actuator or the like. In such alternative configurations the apparatus 110, 150 may be provided such that the hinge mechanism 110 and the releaser 150 are provided by the same electro-mechanical apparatus (e.g. an electro-mechanical actuator that is operated (partially operated) by an electrical user input signal, such as that provided when using the user interface, or the like).

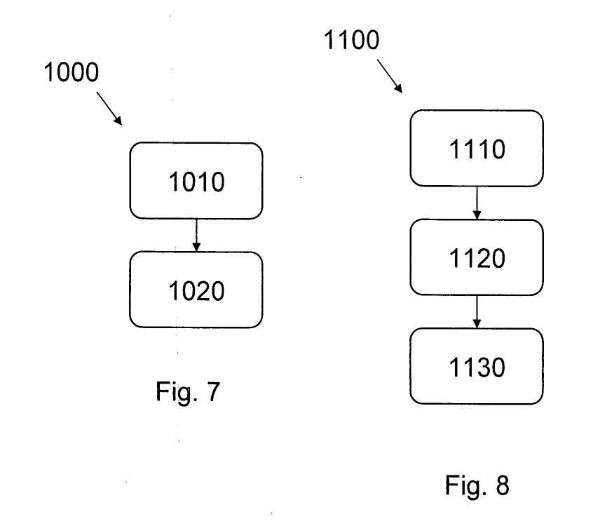

FIG. 7 shows a flowchart 1000 of providing the apparatus 110, 150, wherein there is providing 1010 the hinge mechanism such that it allows for: a closed configuration of a device in which a first member of a device overlays a second member; a partially open configuration in which a first member is slide with respect to a second member such that a first member is laterally displaced along an axis of the hinge with respect to a second member so as to expose a user interface; and an open configuration in which a first member is rotatable relative to a second member around the axis of the hinge so as to expose an inner surface region of each member; and providing 1020 the apparatus so as to allow for the apparatus to urge one of the first member and second members so as to provide for removal of the lateral displacement when a device is moved from the partially open configuration to the open configuration.

FIG. 8 shows a flowchart 1100 of use of the device 200 comprising the apparatus 1110, in which there is moving the device 200 from the closed configuration to the partially open configuration (i.e. sliding one member 300, 400 relative to the other 300, 400, such that there is provided bias energy in the bias spring 130c), moving 1120 the device 200 from the partially open configuration to the open configuration, and 1130 allowing the apparatus 110, 150 (e.g. the bias spring 130c and hinge portion 130a, 130b arrangement) to remove the lateral displacement of the first member 300 relative to the second member 400 such that the device 200 is urged to the closed configuration (e.g. without user actuation being required).

It will readily be appreciated that the above embodiment is exemplary only, and in alternative embodiments the hinge mechanism 110/releaser 150 may be provided differently. For example, the releaser 150 may be integral with the hinge mechanism 110. Similar the magnetic/metallic configuration of the retaining element 160 and slide element 190 may be provided such that the slide element 190 is magnetic and the retaining element 160 is metallic or magnetic. A skilled reader will readily be able to implement such alternative embodiments.

It will also be appreciated that in some further embodiments, the apparatus 110, 150 may be configured to provide a device 200 with two (or more) partially open configurations. In some embodiments the apparatus 110, 150 may be configured to allow for relative sliding of the first and second members 300, 400 in two different directions (e.g. in opposite senses). In such arrangements, a further bias spring may be used for lateral movement in the other direction.

A skilled reader will readily appreciated that while in the above embodiment, the retaining element 160 is provided with the second member 400 and the retainer 170 is provided with the first member 300, in alternative embodiments that need not be the case, and the retaining element 160 may be provided with the first member 300 while the retainer 170 may be provided with the second member 400. Similarly, the release element 180 may be provided with the retaining element 160 (e.g. configured to retract the retaining element 180 from the retainer 170). In addition, the slide element (i.e. the strip) may be provided such that it does not extend under the retainer 180. The retainer may be provided with an alternative locking (e.g. magnetic locking) arrangement. Again, a skilled reader would readily be able to implement such arrangements.

In addition, it may be that the device 200 is not able to be positioned in the (non-useful) configuration shown in FIG. 6. In such arrangements, the apparatus 110, 150 may be provided with a stopper, or the like, preventing the movement of the first/second member 300, 400 such that the device 200 cannot (physically) enter that configuration. In further embodiments, the apparatus 110, 150 may be configured such that the device 200 returns to the closed configuration (e.g. configured to slidably return to the closed configuration), before it is possible to (e.g. automatically) move the device 200 into the open configuration. A skilled reader would readily be able to implement such arrangements.

It will be appreciated to the skilled reader that the apparatus/elements/device and/or other features of particular apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory.

It will be appreciated that the aforementioned apparatus/elements/device may have other functions in addition to the mentioned functions, and that these functions may be performed by the same apparatus/elements/device. For example, the hinge mechanism may provide functionality in addition to providing hinging functionality i.e. not limited to only providing hinging functionality.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-23. (canceled)

24. An apparatus for providing a plurality of hinged configurations to at least one of first and second members of a portable electronic device, the apparatus comprising a hinge mechanism configured to provide for a closed configuration of the device in which the first member of the device overlays the second member, a partially open configuration in which the at least one of the first and second members are slid with respect to one another compared to the closed configuration such that the members are laterally displaced with respect to one another along an axis of the hinge mechanism so as to expose a user interface, and an open configuration in which the at least one of the first and second members are rotated relative to one another around the axis of the hinge mechanism compared to the closed configuration so as to expose an inner surface region of each member, and wherein the apparatus is configured to urge at least one of the first and second members so as to provide for removal of the lateral displacement when the device is urged from the partially open configuration toward the open configuration.

25. An apparatus according to claim 24, wherein the apparatus is further configured to allow for removal of the lateral displacement when the device is in the partially open configuration so as to slidably return the device to the closed configuration.

26. An apparatus according to claim 24, wherein the apparatus is provided with a releaser, the releaser being configured to be user operable in order to slidably return a device to the closed configuration.

27. An apparatus according to claim 26, wherein the releaser comprises a retaining element and a complementary retainer, configured for locking contact when the device is in the partially open configuration.

28. An apparatus according to claim 26, wherein the releaser is configured for magnetic locking contact.

29. An apparatus according to claim 26 wherein the releaser further comprises a release element, configured to allow for urging of the retaining element from the retainer when the device is in the partially open configuration so as to provide for at least one of removal and reduction of the locking contact.

30. An apparatus according to claim 24, wherein the apparatus is configured such that bias energy is provided when the first member is slid with respect to the second member so as to provide the partially open configuration, and the apparatus is configured such that the bias energy can be subsequently used to remove the lateral displacement.

31. An apparatus according to claim 24, wherein the hinge mechanism comprises a first and second hinge portion, the second hinge portion configured to be slideable along, and rotatable around, an axis of the first hinge portion so as to provide for the closed, partially open and open configurations.

32. An apparatus according to claim 31, wherein the second hinge portion is cylindrical, and is configured to house a bias spring.

33. An apparatus according to claim 31, wherein the first hinge portion is configured to restrain a housed bias spring so as to provide for storing of the said bias energy when moving from a closed configuration to a partially open configuration.

34. A member for an electronic device comprised with an apparatus according to claim 24.

35. A member according to claim 34, further comprising one of at least one user input and at least one display.

36. A portable electronic device comprising a first member, a second member and an apparatus according to claim 24, configured to provide the closed, partially open, and open configurations.

37. A device according to claim 36, wherein the first member is provided with a first user interface, comprising at least one of a keypad and a touch screen, on an inner surface region.

38. A device according to claim 37, wherein the first user input interface comprises a partially open user region configured to provide for at least one of user input and user output when the device is in the partially open configuration.

39. A device according to claim 36, wherein the second member is provided with a second user interface comprising a display on an inner surface region.

40. A device according to claim 39, wherein the second user interface comprises a partially open user region configured to provide for at least one of user input and user output when the device is in the partially open configuration.

41. A device according to claim 36, wherein the second member is provided with a third user interface comprising at least one of a keypad, display and touch screen, on an outer surface region.

42. A device according to claim 36, wherein the device has at least one of: mobile radiotelephone functionality; media functionality; multimedia functionality; Global Positioning System functionality; Personal Digital Assistant functionality; and general purpose package functionality.

43. An apparatus for providing a plurality of hinged configurations to at least one of first and second members of a portable electronic device, the apparatus comprising a hinge mechanism configured to provide for a closed configuration of the device in which the first member of the device overlays the second member and in which the respective centers of the members are aligned, a partially open configuration in which the first/second members are slid with respect to one another compared to the closed configuration such that the members are laterally displaced with respect to one another along an axis of the hinge mechanism so as to expose a user interface and such that their respective centers are no longer aligned, and an open configuration in which the first/second members are rotated relative to one another around the axis of the hinge mechanism compared to the closed configuration so as to expose an inner surface region of each member and in which the respective centers of the members are aligned, and wherein the apparatus is configured to urge at least one of the first and second members from the partially open configuration to the open configuration so as to re-align the respective centers of the members when the device is urged from the partially open configuration towards a configuration in which the at least one of the first and second members are rotated with respect to one another around the axis of the hinge mechanism.
